(19) United States
(12) Patent Application Publication
(10) Pub. No.: US 2013/0227469 A1
(43) Pub. Date: Aug. 29, 2013

(54) USER TERMINAL AND METHOD FOR DISPLAYING SCREEN

(71) Applicant: Pantech Co., Ltd., (US)

(72) Inventor: In-Soo PARK, Seoul (KR)

(73) Assignee: Pantech Co., Ltd., Seoul (KR)

(21) Appl. No.: 13/760,402

(22) Filed: Feb. 6, 2013

(30) Foreign Application Priority Data
Feb. 29, 2012 (KR) 10-2012-0021431

(51) Int. Cl. G06F 3/0481

(52) U.S. Cl. CPC G06F 3/0481
USPC 715/788

(57) ABSTRACT

In a mobile device, a display displays a first screen in a first orientation and a second screen in a second orientation. A controller determines a layout of a graphic object on the first screen, and changes the layout of the graphic object to be displayed on the second screen while maintaining a screen ratio of the graphic object. A sensor determines whether the apparatus is in the first orientation or the second orientation. A method for displaying a screen includes displaying a first image in the first orientation, and displaying a second image in the second orientation. The first image includes a major graphic object and a minor graphic object. The second image includes a third portion and a fourth portion, where the third portion corresponds to the major graphic object and has a corresponding screen ratio as the major graphic object.

### CROSS-REFERENCE TO RELATED APPLICATION

This application claims priority from and the benefit under 35 U.S.C. §119(a) of Korean Patent Application No. 10-2012-0021431, filed on Feb. 29, 2012, which is incorporated herein by reference for all purposes as if fully set forth herein.

### BACKGROUND

1. Field

The following description relates to a user interface, and more particularly, to a user terminal and a method for processing a screen of a user terminal.

2. Discussion of the Background

In using a user terminal, a user may turn and use the terminal in the width direction or the height direction. When a user has turned a user terminal from the height direction to the width direction for viewing a portrait screen, the terminal adjusts and displays a screen in a landscape view. For example, when a user terminal is in a landscape view state, the layout of a screen is enlarged in the width direction according to the width of the display screen. However, a method of lengthening the layout of a screen in a landscape view state merely lengthens the screen to both sides by enlarging the layout in the width direction and hiding an empty display region. In this case, a display region is enlarged according to the width dimension, but the display region is not maximized, and moreover its aesthetic appearance may be degraded.

### SUMMARY

The following description relates to a user terminal and a method for processing and displaying a screen thereof, in which a layout is edited to display a landscape view screen that uses a display screen's width in the landscape view.

Additional features of the invention will be set forth in the description which follows, and in part will be apparent from the description, or may be learned by practice of the invention.

Exemplary embodiments of the present invention provide an apparatus, including a display to display a first screen if the apparatus is in a first orientation, and to display a second screen if the apparatus is in a second orientation, a controller to determine a layout of a first graphic object on the first screen, and to change the layout of the first graphic object to be displayed on the second screen while maintaining a screen ratio of the first graphic object, and a sensor to determine whether the apparatus is in the first orientation or the second orientation.

Exemplary embodiments of the present invention provide a method for displaying a screen in a mobile device, including displaying a first image if the mobile device is in a first orientation, and displaying a second image if the mobile device is in a second orientation. The first image includes a first portion and a second portion, the second image includes a third portion and a fourth portion, and the third portion corresponds to the first portion and has a corresponding screen ratio as the first portion.

Exemplary embodiments of the present invention provide a method for displaying a screen in a mobile device, including executing a layout editing target application, displaying a screen of the mobile device in a first orientation, changing an orientation of the mobile device to a second orientation, editing a graphic object displayed on the screen, and displaying the edited graphic object in a first region on the screen in the second orientation. The graphic objected is edited according to a type and hierarchical structure of the graphical object.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of a user terminal according to an exemplary embodiment of the present invention.

FIG. 2 is a block diagram illustrating a configuration of a controller according to an exemplary embodiment of the present invention.

FIG. 3 is a diagram illustrating a communication operation between a layout editing application and a layout editing target application according to an exemplary embodiment of the present invention.

FIG. 4 is a diagram illustrating a structure of a uniform resource identifier (URI) used for communication between a data provider and a data processor according to an exemplary embodiment of the present invention.

FIG. 5 is a diagram illustrating a hierarchical structure of a graphic object group to which an exemplary embodiment of the present invention is applied.

FIG. 6 is a diagram illustrating a screen of the user terminal switching to a landscape view mode according to an exemplary embodiment of the present invention.

FIG. 7A and FIG. 7B are diagrams illustrating screens of the user terminal according to exemplary embodiments of the present invention.

FIG. 8 is a diagram illustrating a screen of the user terminal switching to the landscape view mode in “main type” according to an exemplary embodiment of the present invention.

FIG. 9A and FIG. 9B are diagrams illustrating screens of the user terminal switching to the landscape view mode in “main type” according to an exemplary embodiment of the present invention.

FIG. 10 is a diagram illustrating a screen of the user terminal switching to the landscape view mode in “list type” according to an exemplary embodiment of the present invention.

FIG. 11 is a diagram illustrating a screen of the user terminal displaying a graphic object corresponding to new data when switching to the landscape view mode in “list type” according to an exemplary embodiment of the present invention.

FIG. 12 is a diagram illustrating a screen of the user terminal for describing a layout editing function based on a user's manipulation according to an exemplary embodiment of the present invention.

FIG. 13 is a diagram illustrating a screen of the user terminal for describing a layout editing function based on a user's manipulation according to an exemplary embodiment of the present invention.

FIG. 14 is a flowchart illustrating a method for displaying a screen according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

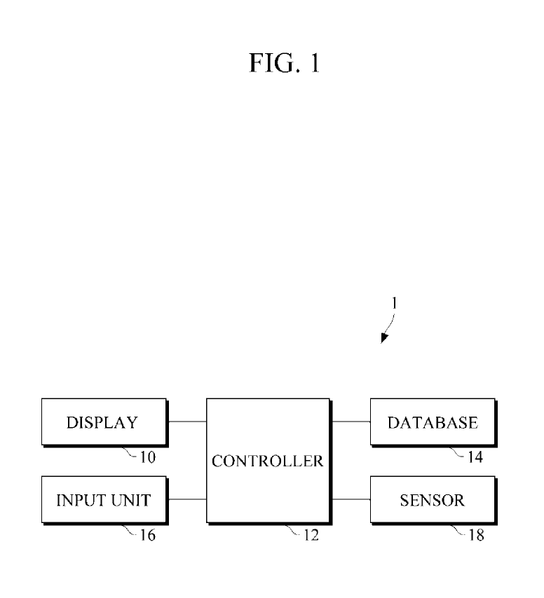

FIG. 1 is a block diagram illustrating a configuration of a user terminal according to an exemplary embodiment of the present invention.

Referring to FIG. 1, the user terminal 1 includes a display 10, a controller 12, a database 14, an input unit 16, and a sensor 18.

When a user switches a screen of the user terminal 1 from a landscape view state to a portrait view state, the mobile terminal 1 provides a screen that is optimized for each of the states. The screen ratio of the user terminal 1, for example, the ratio of a landscape screen to a portrait screen or ratio of a width to height, may be 16:9, 16:10, or 4:3. When a conventional user terminal is switched from the portrait view state to the landscape view state, a screen space is generally wasted because a landscape view screen is not supported, or a portrait view screen is stretched horizontally according to a landscape view screen ratio. But in the user terminal 1, however, the size, position, and configuration of a graphic object of a screen layout are edited to be suitable for the landscape view state, and thus, screen space can be used according to the screen ratio. The graphic object may refer to a graphic user interface (GUI) or a particular image that is displayed on the screen of the user terminal 1, and for example, may be represented as a view on the Android-based user terminal 1.

The user terminal 1 may be any type of device that satisfies a condition in which a user may switch a screen between the landscape view state and the portrait view state. For example, without limitation, the user terminal 1 may be a mobile device that is able to be carried and portable so that a user can change the position of a screen. For example, the user terminal 1 may be a portable phone, a personal digital assistant (PDA), a tablet computer, an e-book reader, a mobile multifunctional device such as a smart phone or a smart pad, or another wireless communication device. Alternatively, the user terminal 1 may be a computer monitor or display with the ability to rotate between landscape view state and portrait view state. The user terminal 1 can provide a landscape view screen that is edited according to one or more of a plurality of applications that may be executed on the user terminal 1.

Hereinafter, the elements of the user terminal 1 as shown in FIG. 1 will be described in more detail below, to describe a layout editing function edited for a screen according to the landscape view state and portrait view state.

The display 10 displays a screen in the landscape view state or portrait view state of the user terminal 1. When the screen position of the user terminal 1 is in the landscape view state, this is referred to as a landscape view mode, and when the screen position of the user terminal 1 is in the portrait view state, this is referred to as a portrait view mode. A view mode may be determined with terminal state information that is acquired from the sensor 18, or the view mode may be set according to a user's input, such as a view mode selection or view mode lock button. The sensor 18 generates a sensing signal to determine whether the orientation of the user terminal 1 is vertical or horizontal, namely, a terminal state. Terminal state information may be information that indicates the current state of the user terminal 1, or it may be information that indicates a change in the state of user terminal 1. that the user terminal 1 has shifted from a previous state to a current state, such as information indicating that the user terminal 1 has rotated from a vertical orientation to a horizontal orientation. The sensor 18 may be, for example, a gyro sensor, an accelerometer sensor, or a geomagnetic sensor. When the sensor 18 has acquired terminal state information, the controller 12 switches the user terminal 1 from the landscape view mode to the portrait view mode or from the portrait view mode to the landscape view mode according to the terminal state information.

The input unit 16 receives a user manipulation command. If the display 10 is a touch screen type, the input unit 16 that receives a touch type of manipulation signal from the user, and the display 10 that displays a processed result corresponding to the input manipulation signal, may be physically disposed as a common element in the same space.

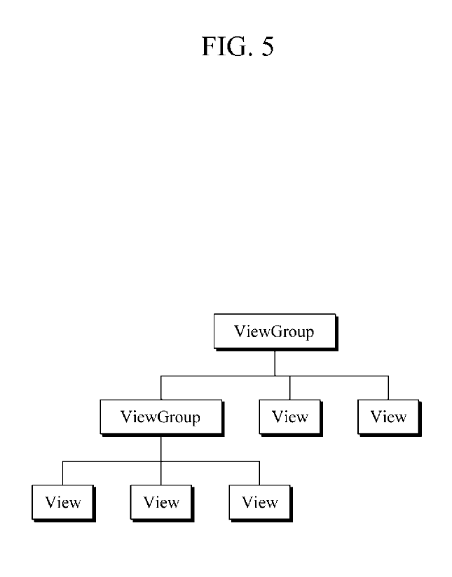

The database 14 stores graphic object-related data to generate graphic objects that are displayed on the display 10. Also, the database 14 stores and manages terminal state information that is acquired from the sensor 18. Graphic objects configuring the layout of a screen are hierarchically configured in groups. The hierarchical structure of a graphic object group will be described in more detail below with reference to FIG. 5.

The controller 12 determines a type and a structure, which include the position and size of a graphic object configuring a screen layout, from the hierarchical structure of the graphic object. The controller 12 edits a layout including the size, position, and configuration of a graphic object that is displayed on the screen of the display 10 when switching a screen between the landscape view state and the portrait view state, on the basis of the determined type and structure of the graphic object. The controller 12 may maintain the screen ratio of the graphic object while editing the layout of the graphic object.

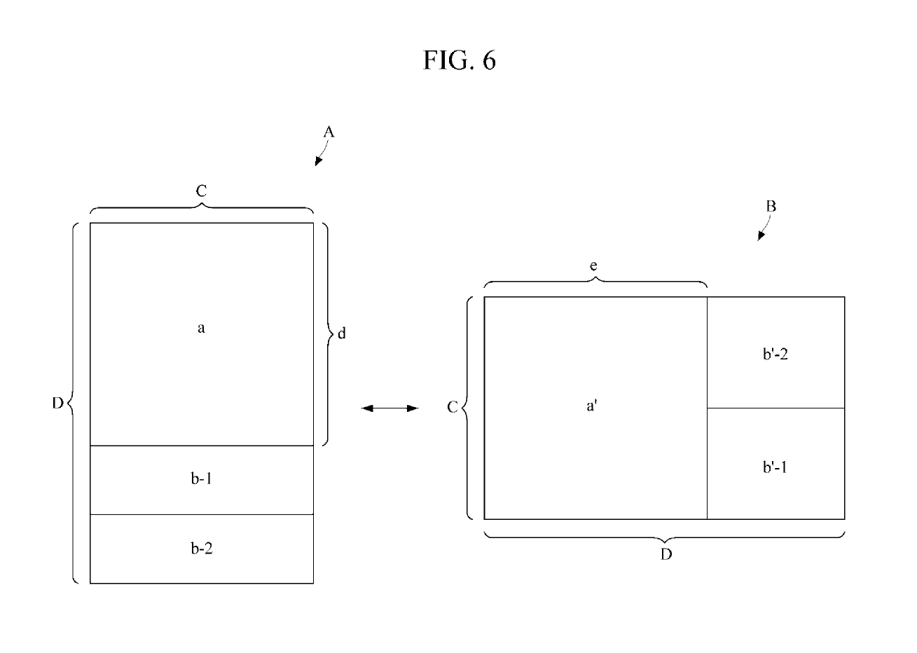

When a screen is switched from a portrait view screen to a landscape view screen on the display 10, the controller 12 determines an upper end region of the portrait view screen having a size corresponding to the width size of the landscape view screen, in the height of the portrait view screen. The controller 12 arranges at least one graphic object, which is positioned in the determined upper end region of the portrait view screen, on the landscape view screen. Subsequently, the controller 12 arranges graphic objects other than a graphic object positioned in an upper end of the portrait view screen, in the other region of the landscape view screen. An embodiment of this will be described in more detail below with reference to FIG. 6.

Thus, the controller 12 may perform layout editing in a landscape view state according to whether a screen type is a “main type” or a “list type”. “Main type” is configured with graphic objects that may not match in size, and is a screen type including a major graphic object that occupies a relatively larger portion of a screen among other graphic objects. “List type” is a screen type that is configured with graphic objects of similar, constant, or uniform size arranged in a list.

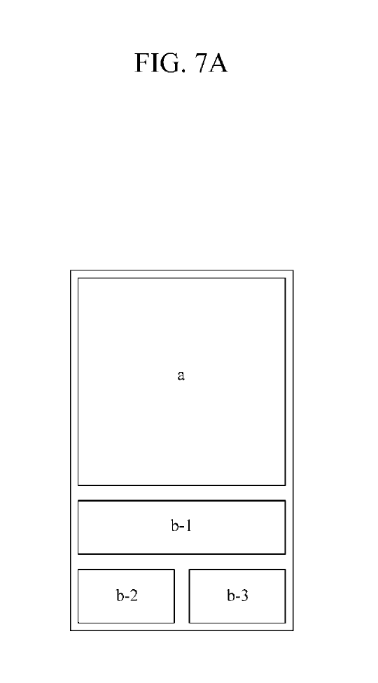

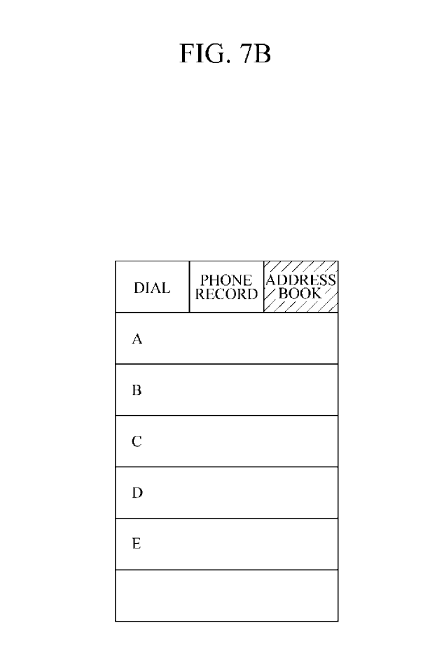

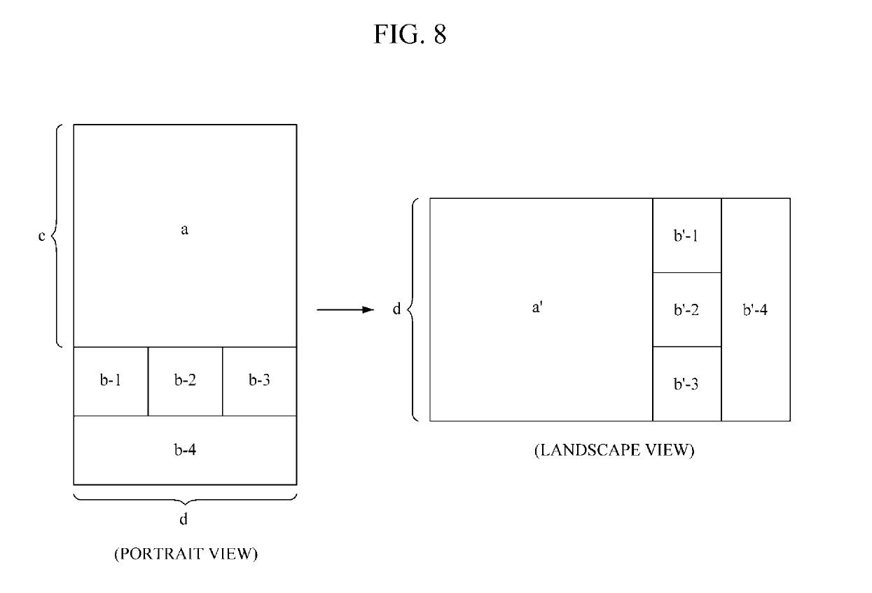

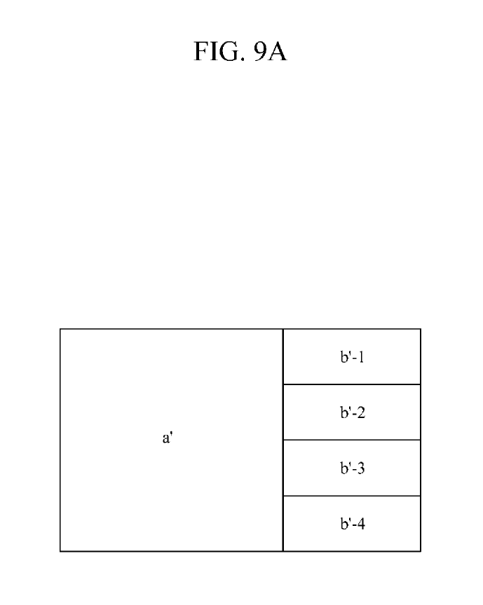

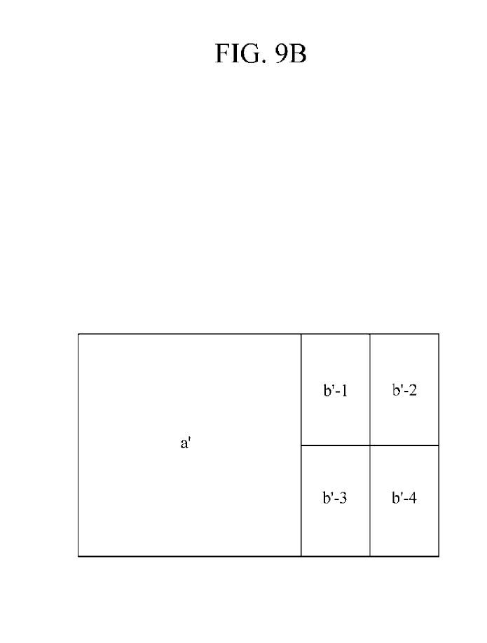

In “main type”, when a screen is switched from the portrait view state to the landscape view state, the controller 12 may arrange the major graphic object in a certain screen region on the landscape view screen, and arrange minor graphic objects other than the major graphic object, so as to be enlarged or reduced, in other regions of the screen. The controller 12 determines a size including the width and area of the major graphic object according to a screen ratio in the landscape view state. Furthermore, the controller 12 determines the arrangement positions of the minor graphic objects other than the major graphic object, in the other regions in which the major graphic object is not displayed. An embodiment of layout editing in a major graphic object type will be described in more detail below with reference to FIG. 7A, FIG. 8, and FIG. 9A, and FIG. 9B.

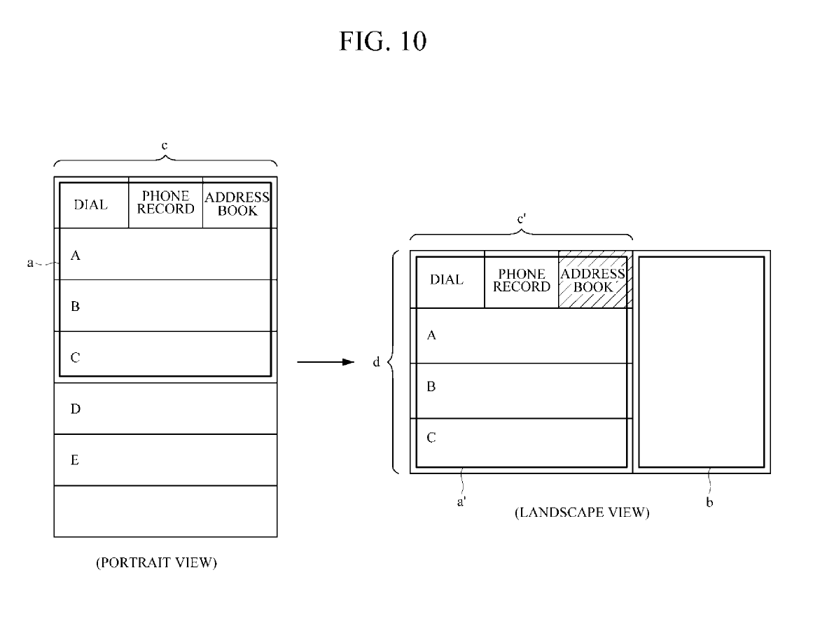

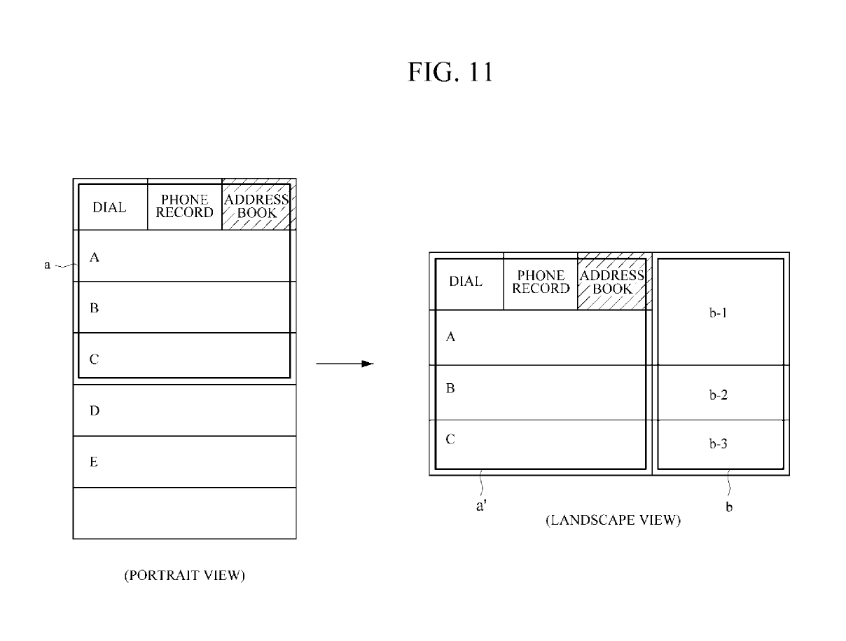

In “list type”, when a screen is switched from the portrait view state to the landscape view state, the controller 12 arranges list-type graphic objects in a certain screen region of the landscape view screen, and additionally arranges graphic objects corresponding to new data associated with data of the list-type graphic objects in other regions of the screen. The controller 12 may display graphic objects that are subordinate to the list-type graphic objects in other regions of the screen. Alternatively, the controller 12 may receive data associated with the list-type graphic objects from another application or the Internet and arrange the received data in other regions of the screen. An embodiment of layout editing in “list type” will be described below in more detail with reference to FIG. 7B, FIG. 10, and FIG. 11.

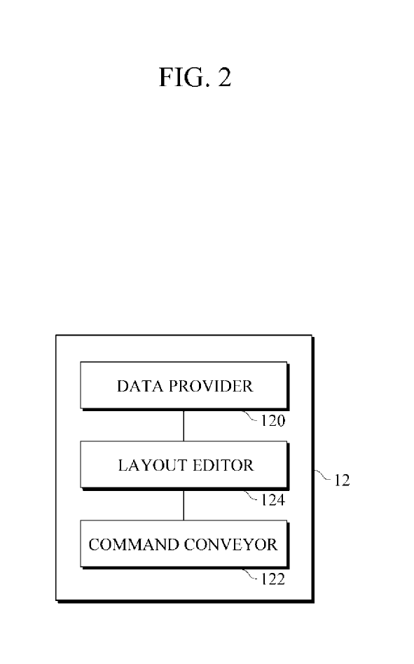

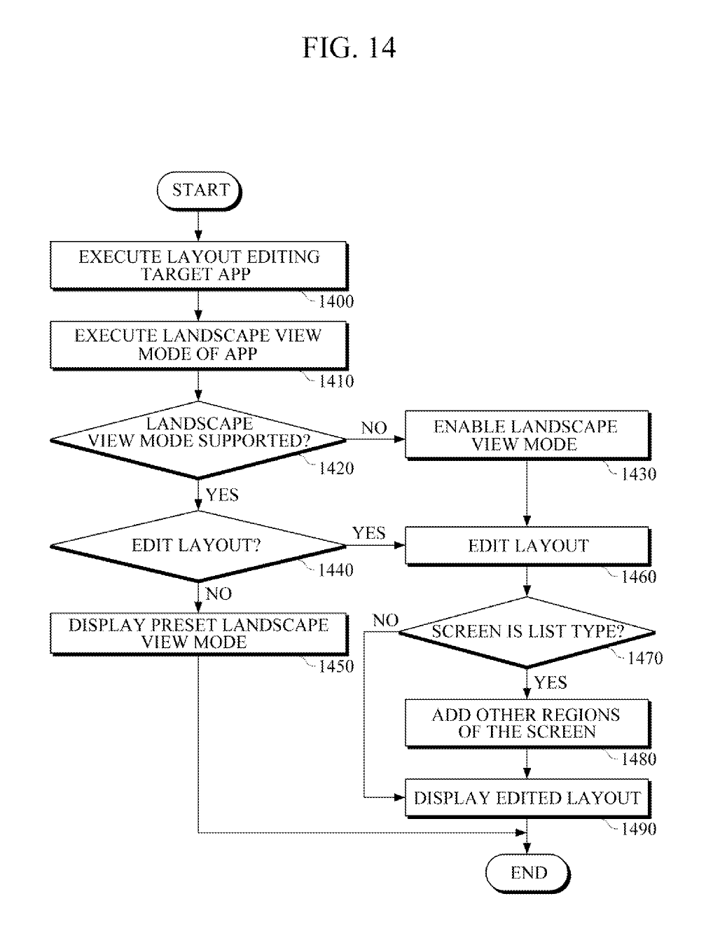

As described above, the controller 12 may provide a layout editing function according to the landscape view state and the portrait view state for applications that are executed in a mobile operating system. The controller 12 may determine whether a layout editing target application supports the landscape view mode and supports layout editing, and supports the landscape view mode and the layout editing function. Layout editing for the layout editing target application will be described in more detail below with configuration of the controller 12 of FIG. 2 and a method for displaying a screen as shown in FIG. 14.

The controller 12 may add, delete, or change the configuration of a graphic object as part of a screen layout according to a user manipulation command that is received from the input unit 16. Alternatively, the controller 12 may adjust a screen ratio between graphic objects configuring a layout, according to the user manipulation command.

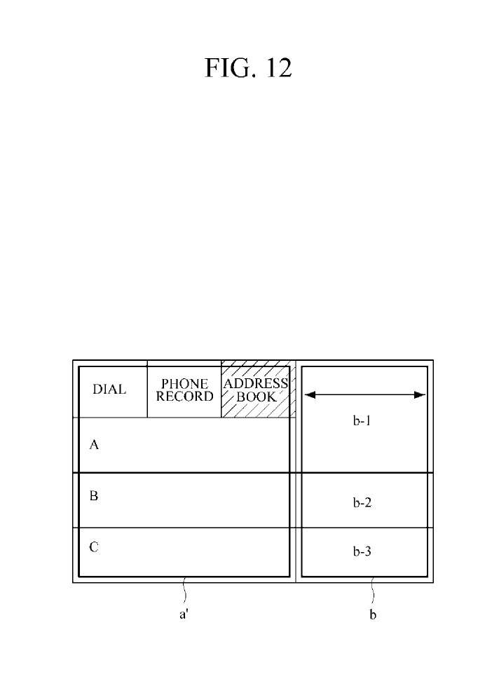

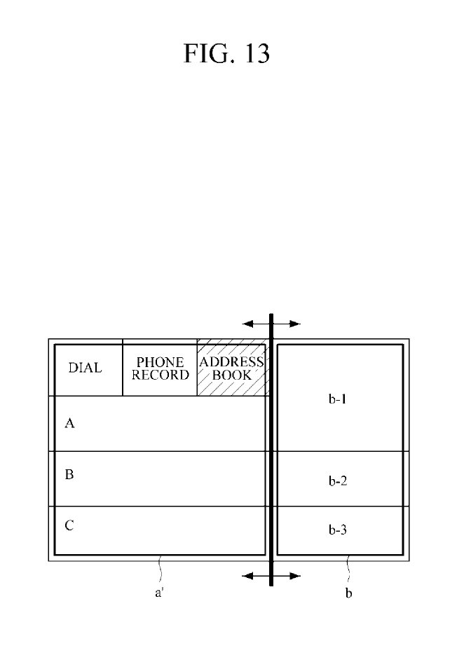

For example, the controller 12 receives data associated with list-type graphic objects from a user through the input unit 16, and arranges graphic objects corresponding to the received data in other regions of the screen on the display 10. As another example, the controller 12 receives a touch manipulation to adjust a ratio between the list-type graphic objects and graphic objects that display data associated with the list-type graphic objects from the user through the input unit 16, and adjusts a screen ratio between the graphic objects displayed on the display 10. A layout editing function according to a user manipulation will be described in more detail below with reference to FIG. 12 and FIG. 13.

FIG. 2 is a block diagram illustrating a configuration of a controller according to an exemplary embodiment of the present invention.

Referring to FIG. 12, the controller 12 includes a data provider 120, a layout editor 124, and a command conveyor 122, so that a layout editing application may edit the layout of the layout editing target application.

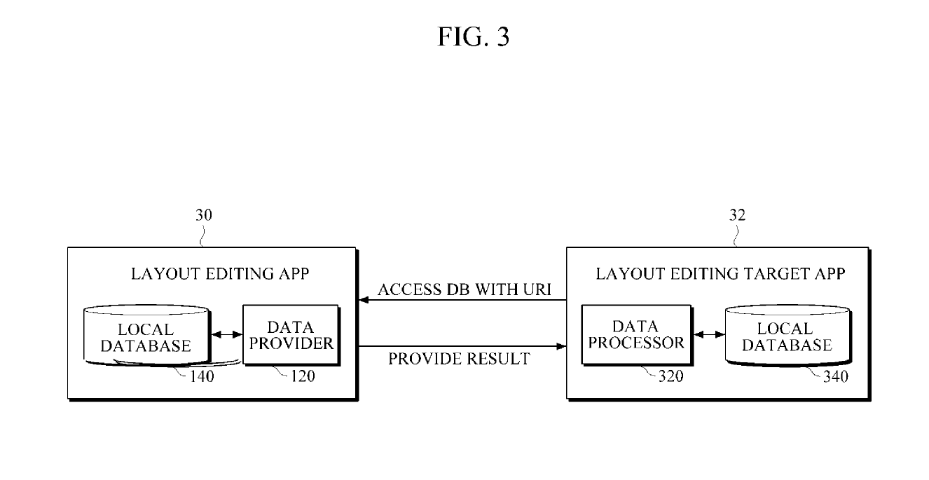

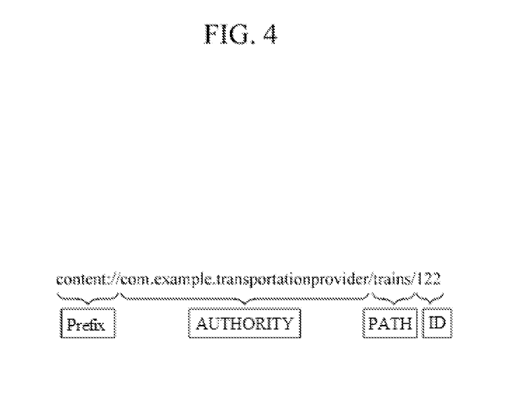

The data provider 120 allows the layout editing application to access data of the layout editing target application or allows data sharing therebetween. The data provider 120 may communicate with a data processor (see 320 of FIG. 3) of the layout editing target application, to provide data access or data sharing. An example of communication between the data provider 120 and the data processor (see 320 of FIG. 3) will be described in more detail below with reference to FIG. 3 and FIG. 4.

The layout editor 124 parses data content of the layout editing target application to determine layout information and, when screen switching between the landscape view state and the portrait view state, edits the size, position, and configuration of a graphic object displayed on a screen on the basis of the determined layout information. The layout information may include the type and structure of a graphic object configuring a layout. The layout information may include information for determining whether to support layout editing, and information for determining whether to support the landscape view mode.

The command conveyor 122 conveys a layout editing command for layout editing by the layout editor 124 to the layout editing target application.

To summarize, the controller 12 parses data content of an application with the layout editor 124, exchanges a command between applications through the command conveyor 122, and performs a series of operations that exchange data through the data provider 120, thereby providing an operational connection between the layout editing application and the layout editing target application.

As an example of an operational connection between applications, the controller 12, including the data provider 120, the command conveyor 122, and the layout editor 124, may generate new data or retrieve stored data associated with a graphic object of a layout configuring a screen having the portrait view state through an operational connection between applications in the landscape view state. The new or stored data may then be displayed on the screen in the landscape view state. As an example, if an application is a social network service (SNS) application, the application displays a graphic object indicating data having a corresponding function on a screen, in operational connection with an application having a function capable of displaying another graphic object or a gallery so as to enable the upload of a photo file.

According to an embodiment, the layout editor 124 determines whether the layout editing target application supports the landscape view mode. If it is determined that the landscape view mode is not supported, the layout editor 124 changes the layout data attribute information of the layout editing target application so as to enable support of the landscape view mode. For example, the layout editor 124 changes attribute information including “view only width” (for example, landscape), “view only height” (for example, portrait), and “cannot switch width and height” (for example, no sensor) to attribute information including “possibility of switching between width and height” (for example, no sensor), in a tag (for example, screenOrientation) of a parsed file. As such, the target application for layout editing may be changed to permit layout editing by the layout editor 124. The layout editor 124 may use the layout editing application to edit the layout of the target application for viewing in the landscape view mode.

The layout editor 124 may determine whether a layout editing target application that supports the landscape view mode supports layout editing, or whether a layout editing target application whose layout data attribute information has been changed so as to enable support of the landscape view mode, supports layout editing. If it is determined that layout editing is not supported by either type of layout editing target application, the layout editor 124 changes the layout data attribute information of the layout editing target application so as to enable support of layout editing, with a layout editing interface. In the layout editing target application, if layout data attribute information is automatically changed when switching to the landscape view mode, this may be regarded as being optimized for the landscape view mode by the developer of the layout editing target application, and thus, layout editing may not be performed where layout data attribute information is automatically changed. However, if layout data attribute information is not automatically changed, layout editing may be performed so as to edit the layout of the target application for viewing in the landscape view mode.

The layout editor 124 may parse data content of the layout editing target application to determine the size of a graphic object configuring a layout in the portrait view mode. Furthermore, the layout editor 124 rearranges the size, position, and configuration of the graphic object according to screen switching between the landscape view state and the portrait view state, on the basis of the determined size of the graphic object. An embodiment of this will be described in more detail below with reference to FIG. 6.

FIG. 3 is a diagram illustrating a communication operation between a layout editing application and a layout editing target application according to an exemplary embodiment of the present invention.

Referring to FIG. 3, a layout editing application 30 includes a local database 140, and a layout editing target application 32 includes a local database 340. Unlike a conventional a local database, which is capable of accessing only a corresponding application, the data provider 120 and the data processor 320 enable access to a local database even among different applications.

The data provider 120 of the layout editing application 30 provides data of the local database 140 to the data processor 320 of the layout editing target application 32 requesting the data. In this case, the data provider 120 communicates with the data processor 320 using a URI.

When the data of the local database 140 of the layout editing application 30 is requested, the layout editing target application 32 transmits a URI to the layout editing application 30. The data provider 120 of the layout editing application 30 analyzes the URI, and provides the data of the local database 140 to the layout editing target application 32 according to the analysis result. The data provider 120 performs operations (create, read, update, and delete). The structure of the URI will now be described in more detail with reference to FIG. 4.

FIG. 4 is a diagram illustrating a structure of a uniform resource identifier (URI) used for communication between a data provider and a data processor according to an exemplary embodiment of the present invention.

Referring to FIG. 4, a prefix of the URI denotes a fixed schema using the data provider 120. Authority is a unique name for recognizing the data provider 120. A path defines the type of data that is provided by the data provider 120. An identifier (ID) is an ID of a requested record. If there is no ID, this denotes all data of the requested record.

FIG. 5 is a reference diagram illustrating a hierarchical structure of a graphic object group to which an exemplary embodiment of the present invention is applied.

Referring to FIG. 5, a root node (graphic object group) of a hierarchical structure allows its children (graphic objects or graphic object groups) to personally draw them. The children may request a size and position thereof inside a parent, which determines the sizes of the children. The graphic object group is a container object that groups a set of child graphic objects. An upper graphic object group calls each of a plurality of lower graphic objects, and determines the size and position of each lower graphic object. Accordingly, the position and size of each graphic object in a screen layout can be determined from the hierarchical structure of the graphic object group.

An operating system analyzes a plurality of layout elements in order descending from the uppermost portion of the hierarchical structure to a plurality of graphic objects, and adds the graphic objects to the parent. Elements are drawn in order and may overlap previously drawn elements.

FIG. 6 is a diagram illustrating a screen of the user terminal switching to a landscape view mode according to an exemplary embodiment of the present invention.

Referring to FIG. 6, when a screen is switched from a portrait view screen A to a landscape view screen B, the user terminal 1 determines an upper end region a of the portrait view screen A, where upper end region a has a height corresponding to a height C of the landscape view screen B. In this example, the portrait view screen A has a height D. Herein, one or more graphic objects may be arranged in the upper end region a of the portrait view screen A.

Subsequently, a graphic object positioned in the determined upper end region a of the portrait view screen A is arranged in a certain region on the landscape view screen B. For example, as illustrated in FIG. 6, the graphic object may be arranged in a left upper end region a′ of the landscape view screen B. Herein, a ratio C:d of the portrait view screen A may be adjusted to be equal to e:C of the landscape view screen B.

Graphic objects other than the graphic object positioned in the upper end region a of the portrait view screen A, for example, b-1 and b-2, are arranged in the other regions, b′-1 and b′-2, of the landscape view screen B. A dimension and/or area ratio b-1:b-2 may be adjusted to be equal to b′-1:b′-2 (i.e., b-1:b-2 =b′-1:b′-2). In FIG. 6, b′-1 and b′-2 are arranged in parallel in the height direction, but they may be arranged in parallel in the width direction. Also, in FIG. 6, the other regions b′-1 and b′-2 are illustrated, but the number of graphic objects in the other regions is not limited to two and may be greater or fewer than two.

FIG. 7A and FIG. 7B are reference diagrams illustrating screens of the user terminal according to exemplary embodiments of the present invention.

FIG. 7A illustrates a screen of “main type”, and FIG. 7B illustrates a screen of “list type”. A “main type” is a screen that includes a major graphic object occupying a relatively larger portion of a screen. For example, the major graphic object may occupy 50% or more of an entire layout in the screen viewed in the portrait view mode. For example, in FIG. 7A, the region a corresponds to the major graphic object, and b-1, b-2, and b-3 correspond to minor graphic objects. A “list type” is a type in which multiple list-type graphic objects are arranged on the screen. For example, as illustrated in FIG. 7B, “list type” is a type in which users A to E included in an address book are listed in rows.

FIG. 8 is a diagram illustrating a screen of the user terminal switching to the landscape view mode in “main type” according to an exemplary embodiment of the present invention.

Referring to FIG. 8, when the user terminal 1 has switched the “main type” screen from the portrait view state to the landscape view state, the controller 12 arranges the major graphic object in a certain screen region on a screen in the portrait view state, and arranges minor graphic objects other than the major graphic object to be enlarged or reduced in other regions of the screen. The controller 12 determines a type, including the position and size of each of the graphic objects in a screen layout, from the hierarchical structure of a graphic object group. The controller 12 edits the position, size, and configuration of the major graphic object and the positions, sizes, and configurations of the respective minor graphic objects, on the basis of the determined type and structure of each graphic object within the hierarchical structure.

The controller 12 determines a size including the width and area of the major graphic object according to a screen ratio in the landscape view state, and determines the arrangement positions of the minor graphic objects other than the major graphic object in the other regions in which the major graphic object is not displayed. For example, as illustrated in FIG. 8, a major graphic object a having the portrait view state moves to a region a′ when the screen of the user terminal 1 is switched from the portrait view state to the landscape view state. In moving, the width-to-height ratio of the major graphic object is not changed, but c corresponding to the height of the major graphic object is enlarged or reduced from a region a to a region a′ according to a length d. When the position of the major graphic object has been determined, the minor graphic objects are enlarged or reduced to the other regions b′-1, b′-2, b′-3, and b′-4. A dimension and/or area ratio b-1:b-2:b-3:b-4 may be adjusted to be equal to b′-1:b′-2:b′-3:b′-4.

The minor graphic objects may be arranged depending on factors related to minor graphic objects b-1, b-2, b-3, and b-4. An exemplary embodiment of this will now be described in more detail with reference to FIGS. 9A and 9B.

FIGS. 9A and 9B are reference diagrams illustrating screens of the user terminal switching to the landscape view mode in “main type” according to an exemplary embodiment of the present invention.

As illustrated in FIG. 9A and FIG. 9B, the minor graphic objects may be variously arranged. For example, as illustrated in FIG. 9A, b′-1, b′-2, b′-3, and b′-4 may be arranged in a 4×1 matrix, i.e., in one column. Or, as illustrated in FIG. 9B, b′-1, b′-2, b′-3, and b′-4 may be arranged in a 2×2 matrix. For arrangements of the minor graphic objects, the controller 12 determines the type of a graphic object, including the position and size of each of the graphic objects in a screen layout, from the hierarchical structure of a graphic object group. Then the controller 12 may determine whether the graphic objects in a screen layout have similar or different hierarchical arrangements, and may determine whether to allocate equal screen space for each minor graphic object or whether to allocate greater screen space to one graphic object or category or hierarchy of graphic object. The available screen space for minor graphic objects may be set according to the remaining space in which the major graphic object is not displayed, and the layout of the minor graphic objects in the landscape view mode may be selected in order to maintain a screen ratio that is similar to the screen ratio of each minor graphic object in the portrait view mode.

FIG. 10 is a diagram illustrating a screen of the user terminal switching to the landscape view mode in “list type” according to an exemplary embodiment of the present invention.

Referring to FIG. 10, one landscape view screen processing difference between “main type” and “list type” is that “list type” may display a minor graphic object corresponding to new or stored data that is different from data on a portrait view screen in other regions of the screen, unlike “main type”. That is, when the user terminal 1 having the “list type” screen has been switched from the portrait view state to the landscape view state, the user terminal 1 arranges list-type graphic objects in a certain screen region on a screen, and additionally arranges a minor graphic object corresponding to new or stored data associated with data of the list type graphic object in other regions of the screen.

For example, as illustrated in FIG. 10, a layout in the landscape view state is configured with a graphic object group a′ corresponding to data in the portrait view state, and a graphic object group b corresponds to new or stored data retrieved from a database. Herein, a width c′ of the graphic object group a′ is equal to a width c of a layout in the portrait view state. The height d′ of the graphic object group a′ is set according to a length d of the user terminal 1's display 10. However, when the height of the graphic object group a′ is insufficient compared to the length d, the user terminal 1 may generate a height scroll bar on a screen, thereby enabling display of the graphic object group a′ in an additional region through scroll control. In scroll control of the graphic object group a′, the graphic object group b may also be scrolled simultaneously, and data of the graphic object group b synchronized with data of the graphic object group a′ may be displayed.

FIG. 11 is a diagram illustrating a screen of the user terminal displaying a graphic object corresponding to new data when switching to the landscape view mode in “list type” according to an exemplary embodiment of the present invention.

Referring to FIG. 11, the controller 12 displays a graphic object that is subordinate to list-type graphic objects in a screen region other than a screen region in which the list-type graphic objects have been arranged.

For example, when the layout editing target application is an application providing an address book, as illustrated in FIG. 11, a graphic object corresponding to lower level data of a user A is displayed in b-1 of other regions of the screen b′. Lower level data may be a telephone number, an e-mail address, recent message content, or group information. Likewise, a graphic object corresponding to lower level data of a user B and a graphic object corresponding to lower level data of a user C may be respectively displayed in b-2 and b-3 of other regions of the screen b′.

The controller 12 may receive data associated with the list-type graphic objects from another application and may arrange graphic objects corresponding to the received data in other regions of the screen. For example, if the layout editing target application is an application for providing an address book, the controller 12 receives new data in operational connection with an application associated with user list data in the address book, namely, an SNS-related application, and arranges graphic objects corresponding to the received data in other regions of the screen b′. For example, as illustrated in FIG. 11, the controller 12 may display the recent mention and image data of the user A, which are received in operational connection with the SNS-related application, in b-1 of the other region of the screen b′.

Similarly, if the layout editing target application is a music reproduction application, the controller 12 may display a musician, a music title, and a music length in a region a′, and display encoding, sound quality information, file size information, a homepage link of a musician, SNS mention, a photo, and recommended music in a region b. If the layout editing target application is a household account book, the controller 12 may display date, card type, transaction name, and sum of money in the region a′, and display transaction classification information, card transaction location information, and card point accumulation information in the region b. If the layout editing target application is a bus stop information provision application, the controller 12 may display a running bus number, position of a bus, and predicted arrival time for a bus in the region a′, and display last bus information, bus line link, and a shortcut icon in the region b. When the layout editing target application is a dictionary, the controller 12 may display a list of words in the region a′, and display meanings of words and a web dictionary link in the region b. If the layout editing target application is a chatting application, the controller 12 may display the name and contact number of a friend in the region a′, and display a profile preview and recent mention using SNS in the region b. If the layout editing target application is a file searcher, the controller 12 may display a list of files or folders in the region a′, and display a folder size or a file size in the region b. If the layout editing target application is a memo pad, the controller 12 may display a list of recorded memos in the region a′, and display a memo deletion icon, a memo editing icon, and web search of memo titles in the region b. The above-described embodiments are merely examples to aid in understanding of the scope of disclosure, and various alternative embodiments can be implemented.

FIG. 12 is a diagram illustrating a screen of the user terminal for describing a layout editing function based on a user's manipulation according to an exemplary embodiment of the present invention.

Referring to FIG. 12, the controller 12 may add, delete, or change the configuration of a graphic object configuring a screen layout according to a user manipulation command. For example, as illustrated in FIG. 12, the controller 12 may add, delete, or change the configuration of a graphic object in the other region b according to a user's manipulation. In this case, a user manipulation command may be a drag operation corresponding to a touch of a corresponding region. The user manipulation command may be input by a scheme such as a touch or recognition of a user's gesture.

FIG. 13 is a diagram illustrating a screen of the user terminal for describing a layout editing function based on a user's manipulation according to an exemplary embodiment of the present invention.

Referring to FIG. 13, the controller 12 may adjust a screen ratio between graphic objects included in a layout according to a user manipulation command. For example, as illustrated in FIG. 13, the controller 12 may adjust a ratio between the region a′ and region b through a touch and drag operation of the user. The user manipulation command may be input by a scheme such as a touch or recognition of a user's gesture.

FIG. 14 is a flowchart illustrating a method for displaying a screen according to an exemplary embodiment of the present invention.

Referring to FIG. 14, the layout editing target application is executed in operation 1400. When a view mode is switched to the landscape view mode in operation 1410, the user terminal 1 determines whether the layout editing target application supports the landscape view mode in operation 1420. If it is determined that the landscape view mode is not supported by the target application, the user terminal 1 changes the layout data attribute information of the layout editing target application so as to enable support of the landscape view mode in operation 1430.

If it is determined that the landscape view mode is supported in operation 1420, the user terminal 1 determines whether a layout editing target application, which supports the landscape view mode, or the layout editing target application whose layout data attribute information has been changed to enable support of the landscape view mode, supports layout editing in operation 1440. If it is determined that layout editing is not supported by the target application for layout editing, the user terminal 1 changes the layout data attribute information of the layout editing target application to enable support of layout editing by using a layout editing interface, and starts to edit a layout in operation 1460. On the other hand, in the layout editing target application, when layout data attribute information is automatically changed when switching to the landscape view mode, the user terminal 1 may determine that the layout data attribute information is optimized for the landscape view mode by the developer of the layout editing target application. In this case, if the the layout data attribute information is determined to be optimized, the user terminal 1 may not perform layout editing, such as shown in operation 1450.

Following operation 1460, the user terminal 1 determines the type of a graphic object configuring a screen layout. The user terminal 1 edits the size, position, and configuration of a graphic object displayed on a screen on the basis of the determined type and structure of the graphic object, and displays the edited layout on the screen in operation 1490. More specifically, the user terminal 1 determines whether the screen is “main type” or “list type” in operation 1470. When it is determined that the screen is “main type,” the user terminal 1 proceeds to operation 1490. In operation 1470, when it is determined that the screen is “list type”, the user terminal 1 may add new data to other regions of the screen in operation 1480. Then, the user terminal 1 displays the edited layout on the screen in operation 1490.

According to the above-described embodiments, by editing the arrangement of the layout in the landscape view state of the user terminal, screen space in the landscape view state can be used and an aesthetic appearance may be improved. Furthermore, in rearranging the layout, a new data-related graphic object may be arranged in operational connection with data of an application and another application.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components having substantially similar performances or their equivalents. Accordingly, it will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus, comprising:
a display to display a first screen if the apparatus is in a first orientation, and to display a second screen if the apparatus is in a second orientation;
a controller to determine a layout of a first graphic object on the first screen, and to change the layout of the first graphic object to be displayed on the second screen while maintaining a screen ratio of the first graphic object; and
a sensor to determine whether the apparatus is in the first orientation or the second orientation.

2. The apparatus of claim 1, further comprising:
a database comprising data associated with the first graphic object.

3. The apparatus of claim 2, wherein the controller retrieves the data associated with the first graphic object from the database, and controls the display to display the data associated with the first graphic object on the second screen in a region where the first graphic object is not displayed.

4. The apparatus of claim 1, wherein the controller determines a layout of a second graphic object on the first screen, and changes the layout of the second graphic object to be displayed on the second screen in a region where the first graphic object is not displayed.

5. The apparatus of claim 4, wherein the second graphic object comprises a plurality of minor graphic objects, and respective screen ratios of the minor graphic objects displayed on the second screen are set according to relative positions in a hierarchical structure of a graphical object group.

6. The apparatus of claim 4, wherein a screen ratio of the second graphic object displayed on the first screen is different than a screen ratio of the second graphic object displayed on the second screen.

7. The apparatus of claim 1, wherein the first graphic object is a major graphic object displayed on the first screen.

8. The apparatus of claim 1, wherein the controller comprises:
a data provider to exchange data between a layout editing application and a layout editing target application; and
a layout editor to determine the layout of the first graphic object on the first screen, and to edit the layout of the first graphic object to be displayed on the second screen if the apparatus changes between the first orientation and the second orientation.

9. A method for displaying a screen in a mobile device, comprising:
displaying a first image if the mobile device is in a first orientation; and
displaying a second image if the mobile device is in a second orientation,
wherein the first image comprises a first portion and a second portion, the second image comprises a third portion and a fourth portion, and the third portion corresponds to the first portion and has a corresponding screen ratio as the first portion.

10. The method of claim 9, wherein the fourth portion corresponds to the second portion and has a different screen ratio than the second portion.

11. The method of claim 10, wherein the fourth portion comprises a plurality of sub-portions corresponding to sub-portions of the second portion, and the sub-portions of the fourth portion have different screen ratios than the sub-portions of the second portion.

12. The method of claim 11, wherein respective screen ratios of the sub-portions of the fourth portion are set according to relative positions in a hierarchical structure of a graphical object group.

13. The method of claim 9, wherein the fourth portion has a different screen ratio than the second portion.

14. The method of claim 13, wherein the sub-portions of the fourth portion comprise data associated with data displayed in the third portion.

15. The method of claim 14, wherein in a first sub-portion of the fourth portion, the data comprises at least one of a telephone number, an e-mail address, a recent message content, and group information.

16. A method for displaying a screen in a mobile device, comprising:
executing a target application;
displaying a screen of the mobile device in a first orientation;
changing an orientation of the mobile device to a second orientation; and
editing a graphic object displayed on the screen and displaying the edited graphic object in a first region on the screen in the second orientation,
wherein the graphic objected is edited according to a type and hierarchical structure of the graphical object.

17. The method of claim 16, further comprising:
adding new data to a second region of the screen in the second orientation.

18. The method of claim 17, wherein the new data corresponds to the graphic object.

19. The method of claim 16, further comprising changing layout data attribute information of the target application to support layout editing.

20. The method of claim 16, wherein editing the graphic object further comprises changing a size and position of the graphic object while maintaining a screen ratio of the graphic object.
